(19) United States
(12) Patent Application Publication
(10) Pub. No.: US 2016/0160886 A1
(43) Pub. Date: Jun. 9, 2016

(54) IMPROVEMENTS IN HYDRAULIC SERVOVALVES

(71) Applicant: Moog Controls Limited, Tewkesbury Gloucestershire (GB)

(72) Inventor: Michael Baker, Gretton, Gloucestershire (GB)

(21) Appl. No.: 14/907,830

(22) PCT Filed: Jul. 4, 2014
(86) PCT No.: PCT/GB2014/052038

§ 371 Date: Jan. 27, 2016

(30) Foreign Application Priority Data
Jul. 30, 2013 (GB) 1313612.2

(51) Int. Cl. F15B 13/043

(52) U.S. Cl. CPC F15B 13/0438

(57) ABSTRACT

A servovalve pilot stage assembly is provided having a first fluid conduit (152) having a first orifice (156), a second fluid conduit (154) having a second orifice (158), a flapper (44) having a deformable first region (176) disposed between the first orifice and the second orifice, an actuator (24) arranged to drive the flapper (44) from a first condition in which the first region of the flapper has a first width between the first and second orifice to a second condition in which the first region of the flapper has a second width between the first and second orifice, the second width being less than the first width.

### CROSS-REFERENCE TO RELATED APPLICATIONS

The present application is the U.S. national phase of International Application No. PCT/GB2014/052038 filed Jul. 4, 2014 which claims priority of British Application No. 1313612.2 filed Jul. 30, 2013, the entirety of which is incorporated herein by reference.

### FIELD OF THE INVENTION

The present invention is concerned with hydraulic servovalves. More particularly, the present invention is concerned with single stage and multiple stage nozzle-flapper type hydraulic servovalves for use in a variety of industries, including but not limited to aerospace, motorsport and industrial process control.

### BACKGROUND OF THE INVENTION

Servovalves are used to magnify a relatively low power input signal (usually an electrical control signal in the order of a fraction of a Watt) to a high power hydraulic output (in the order of many thousands of Watts). Several types of hydraulic servovalves are known in the art—for example deflector jet, jet pipe and nozzle flapper. Each operates by using a pilot stage to create a differential pressure at either end of a spool (the “main stage”). The spool controls the flow of the high pressure working fluid. Servovalves typically comprise some kind of mechanical or electronic feedback system from the main stage to the pilot stage.

The present invention concerns nozzle-flapper type hydraulic servovalves. Nozzle-flapper type hydraulic servovalves are well known in the art. A prior art nozzle-flapper servovalve is shown in FIGS. 1 and 2 of the appended drawings.

Referring to FIG. 1, a nozzle-flapper type electro-hydraulic servovalve (EHSV) 10 is shown schematically and in cross-section. The servovalve 10 comprises a pilot stage subassembly 12 and a main stage subassembly 14 as will be described in more detail below.

The pilot stage subassembly 12 defines a main central axis A and comprises a housing cover 16 and a cylindrical base 18 which co-operate to define an enclosed volume 20. The base 18 comprises an annular flange 88 which seals against the housing cover 16. The base 18 further defines a central coaxial bore 22 extending along the main central axis A, and two diametrically opposed bores 52, 54 extending radially from the main central axis A. Each of the bores 52, 54 is in fluid communication with the bore 22. Within each bore 52, 54 there is provided a respective conduit 53, 55 (only shown in FIG. 2) defining a respective fluid nozzle 56, 58. The conduits 53, 55 are adjustable along a common nozzle axis Z within the bores 52, 54.

Contained within the volume 20 there is provided an electro-magnetic actuator 24 comprising a first set of windings 26 and a second set of windings 28. An armature 30 is provided comprising a tubular, cylindrical body 38 with a first leg 34 and a second leg 36 extending radially outwardly therefrom. The first leg 34 is disposed within the first set of windings 26 and the second leg 36 is disposed within the second set of windings 28.

The legs 34, 36 are ferromagnetic and as such the armature is arranged for rotation about an armature axis R, intersecting and perpendicular to the main central axis A when the respective windings 26, 28 are energised by a control signal.

A flapper 44 is provided and is generally tubular and cylindrical in structure. The flapper 44 has a bore 84 concentric therewith. Turning to FIG. 2, the flapper has a free end 75 and a fixed end 46. The flapper 44 comprises a body defining, starting from the free end 75, a first region 76, a second region 78, a third region 80 (with a higher wall thickness than the first and second regions) and a fourth region 82 which terminates in a shoulder 74. The first region 76 and the second region 78 are identical in inner and outlet diameter with the exception that the first region 76 has diametrically opposed flats 77, 79. The shoulder 74 is connected to a collar 72 at the fixed end 46 having a diameter dimensioned for an interference fit with the body 38 of the armature 30.

A flexure sleeve 40 is provided, which is generally tubular and cyclindrical in shape having an internal bore 41. The flexure sleeve has a first end 90 and a second end 92 where it is provided with a surface mounting formation.

A feedback wire 50 is provided which is solid, cylindrical and extends from a first end 51 to a second end 53. The first end 51 comprises a solid collar.

The pilot stage assembly 12 is assembled as follows.

The collar 72 of the flapper 44 is fitted into the body 38 of the armature 30 such that the fixed end 46 is secured to the armature and as such the flapper 44 is cantilevered thereto. The flapper 44 extends from the fixed end 46, past the axis R to the free end 75. With the exception of the collar 72, an annular gap is provided between the flapper 44 and the body 38 of the armature 30.

The flexure sleeve 40 is fitted around the part of the third region 80 and the fourth region 82 of the flapper 44, and is dimensioned such that the second end 92 terminates partway down the flapper where it is mounted to the base 18 such that its internal bore 41 is in communication with the bore 22 of the base 18. As such, the flapper sits in the annular gap between the flapper 44 and the body 38 of the armature 30. The flexure sleeve 40 is closely fitted to the flapper 44 providing an annular gap between the flexure sleeve 40 and the body 38 of the armature 30.

The first end 51 of the feedback wire 50 is fitted into the fixed end 46 of the flapper 44. The feedback wire is therefore fixed within the armature at the same position as the flapper 44. The feedback wire 50 extends beyond the free end 75 of the flapper 44 to protrude from the base 18.

The flapper 44 extends into the bore 22 in the base 18 such that the first region 76 is disposed between the nozzles 56, 58, creating a “hydraulic bridge”—i.e. an arrangement of the nozzles 56, 58, the gaps between the flapper 44 and the nozzles 56, 58 and the inlet orifices. The nozzles 56, 58 are thereby directed onto the flats 77, 79 of the flapper 44. A clearance gap is provided between each of the nozzles 56, 58 and the flapper 44.

Turning to the main stage 14, there is provided a valve 60 comprising a spool 62. The spool has end pressure faces 64, 66. The spool is arranged to move along a spool axis B to control a flow through the valve 60 in a known manner. In various applications, the movement of the spool 62 directs fluid flow so as to control external apparatus such as actuators, pumps, etc.

Movement of the spool 62 along the axis B is achieved by the application of differential pressure to the pressure faces 64, 66 respectively. Each of the pressure faces 64, 66 is open to a respective pressure chamber 68, 70 respectively. Each chamber is in fluid communication via supply lines 6, 8 to a high pressure source (not shown). Each chamber 68, 70 is also in fluid communication with a respective one of the first and second channels 52, 54 of the base 18 of the pilot stage (and therefore is in fluid communication with the conduits 53, 55). Each chamber 68, 70 is also in communication with an external pressure source (not shown).

In operation, the known electro-hydraulic servovalve operates as follows.

In the null position as shown in FIG. 1, without the coils 26, 28 being energised, the flapper 44 sits equidistantly between the nozzle outlets 56, 58. As such, the pressure on either end of the spool 62 is equal.

Should it be desired to move the spool to the left to control the flow through the valve 60, then the first and second windings 26, 28 are energised in order to rotate the armature 30 in an anti-clockwise direction about the armature axis R. This has the effect of rotating the flapper 44 such that the first region 76 moves towards the nozzle 58 and away from the nozzle 56. During this movement the flexure sleeve 40 elastically deforms by virtue of its attachment to the base 18.

The reduction in the flow gap between the nozzle 58 and the flapper 44 results in a rise in pressure upstream of the conduit 55. This creates a higher pressure in the chamber 70 and consequently at the second pressure face 66 on the spool 62. The opening of the gap between the nozzle 56 and the flapper 44 causes a reduction in pressure upstream of the conduit 53 and therefore lowers the pressure in the chamber 68 and reduces the pressure on the face 64. As a result, the spool travels to the left.

As can be seen in FIG. 1, the feedback wire 50 is connected to the centre of the spool 62. As the spool 62 moves towards its desired position the feedback wire 50 is deformed and a torque, opposing the electrically generated torque, is generated on the armature 30. When the desired spool position is reached, the mechanical and electrical torques balance and the flapper has returned to the null position between the nozzles (albeit with a bend in the feedback wire 50). In this condition the differential pressure across the spool 62 is now zero and the spool stops moving. In other words, this is negative position feedback control of the spool 62.

When the coils are deenergised the electrical torque on the armature 30 is removed but because the spool is still displaced from the mid position the mechanical torque from the feedback wire 50 remains. The net effect is to rotate the armature 30 in a clockwise direction which moves the flapper 44 towards the nozzle 56 and away from the nozzle 58. This generates a differential pressure across the spool 62 that positively drives the spool back towards the null position. When the spool reaches the mid position the feedback wire is no longer bent, the net torque is zero and the differential pressure is zero so the spool stops in the mid position.

As mentioned, the electro-hydraulic servovave 10 is connected to a constant pressure source into the chambers 68, 70 (via lines 6, 8). In the null position, because of the gaps between the nozzles 56, 48 there is a quiescent leakage into the bore 22, which then flows to a drain. This quiescent leakage flow is undesirable—it is wasted energy which makes operation of the valve inefficient and expensive.

### SUMMARY OF THE INVENTION

It is an aim of the present invention to reduce quiescent flow in nozzle-flapper type hydraulic servovalves.

According to a first aspect of the invention there is provided a servovalve pilot stage assembly comprising:

a first fluid conduit having a first orifice;

a second fluid conduit having a second orifice;

a flapper having a deformable first region disposed between the first orifice and the second orifice;

an actuator arranged to drive the flapper from a first condition in which the first region of the flapper has a first width between the first and second orifice to a second condition in which the first region of the flapper has a second width between the first and second orifice, the second width being less than the first width so as to separate, or further separate, the flapper and the first orifice.

By “deformable”, we mean the first region can be elastically compressed to reduce its width. The first region is elastically, or resiliently, compressible.

Advantageously, by providing a flapper which is deformable, the flow orifices can be placed much closer to the flapper in the null position reducing quiescent flow. During actuation, the required gap between the flapper and the orifices is created by elastic deformation of the flapper. In the present invention, the orifices can even be placed in contact with the flapper in the null position to reduce flow significantly, or almost eliminate it all together (dependent upon the sealing effect between the flapper and the outlet). In some circumstances, the flapper can be pre-compressed by having the gap between the nozzles less than the uncompressed width of the flapper in the first region.

Preferably the first region is hollow having a wall and a central cavity. This facilitates deformation and allows passage of a feedback wire therethrough.

Preferably, the first region of the flapper is locally, structurally weakened to elastically deform. The flapper defines: a main longitudinal axis; a width extending between the orifices; and, a depth extending normal to the main longitudinal axis and the width; in which an opening/openings is/are formed through the depth of the first region of the flapper. Advantageously, such openings allow elastic deformation to take place by locally reducing the stiffness of the flapper.

Preferably the flapper comprises a free end proximate the first region, and the opening is a/are blind slot/slots generally extending in direction of the main longitudinal axis from the free end, through the first region to form a first leg and a second leg of the flapper in the first region. Such slots are relatively simple to manufacture.

Preferably the blind slots are diametrically opposed.

Preferably the slot or slots terminate in a curved end region which may be partially circular, and preferably has a diameter greater than the width of the slot proximate the circular curved end region. This acts to eliminate the stress raiser at the end of the slot.

The slot or slots may be of constant width along substantially their entire length, alternatively they may taper to alter the characteristics of the flapper.

Preferably at least one of the first and second conduits defining the first and second respective orifices are in contact with the first region of the flapper in the first condition. Preferably both the first and second conduits defining the first and second respective orifices are in contact with the first region of the flapper in the first condition. The first region of the flapper may have an undeformed width greater than the distance between the first and second orifices such that in the first condition the first region of the flapper is pre-compressed. This reduces quiescent flow to an absolute minimum.

Preferably the first region of the flapper defines flats facing the first and second orifices. This improves sealing contact with the flat orifices.

Preferably the first and second orifices are defined in nozzles directed towards the flapper.

According to a second aspect of the invention there is provided a servovalve comprising:

a servovalve pilot stage assembly according to the first aspect; and,

a main stage controlled by the pilot stage

Preferably the servovalve comprises a spool valve having a spool defining a first end face in fluid communication with the first conduit.

The spool preferably defines a second, opposite, end face in fluid communication with the second conduit.

Preferably the first conduit is in fluid communication with:

a pressure source such that the first orifice is an outlet; and,

a first part of the main stage,

in which the fluid pressure at the first part of the main stage is controlled by the distance between the flapper and the first orifice.

The first part is preferably in fluid communication with one end of a spool valve to move it in a first axial direction.

Similarly, the second conduit is preferably in fluid communication with:

a pressure source such that the second orifice is an outlet; and,

a second part of the main stage,

in which the fluid pressure at the second part of the main stage is controlled by the distance between the flapper and the second orifice.

The second part can be placed in fluid communication with the opposite end of the spool valve to move it in the opposite direction.

Preferably there is provided a drain port between the first and second orifices.

As an alternative to a traditional nozzle/nozzle valve, the servovalve may be a nozzle/elzzon valve in which:

the first conduit is in fluid communication with a pressure source such that the first orifice is an outlet;

the second conduit is a connected to a fluid drain such that the second orifice is an outlet;

a third fluid conduit is provided between the first and second fluid orifices in fluid communication with a first part of the main stage;

in which the fluid pressure at the first part of the main stage is controlled by the position of the flapper between the first and second orifices.

Advantageously this type of valve is single inlet and as such mitigates and potential “hard over” failure mode. The main stage will likely require a return mechanism.

### BRIEF DESCRIPTION OF THE DRAWING VIEWS

An example electro-hydraulic servovalve pilot stage in accordance with the present invention will now be described with reference to the accompanying figures in which:

FIG. 1 is a schematic section view of a known electro-hydraulic servovalve;

FIG. 2 is a detail view of a part of the valve of FIG. 1;

FIG. 3 is a detail view of a part of first electro-hydraulic servovalve in accordance with the present invention, similar to the view of FIG. 2;

FIG. 4a is a detail view of a part of the servovalve FIG. 3;

FIG. 4b is a section view along line BB of FIG. 4a;

FIG. 5 is a view of the valve of FIG. 4a in a deformed state;

FIG. 6 is detail view of a part of a second electro-hydraulic servovalve in accordance with the present invention; and

FIG. 7 is a detail view of a part of a third electro-hydraulic servovalve in accordance with the present invention.

### DETAILED DESCRIPTION OF THE INVENTION

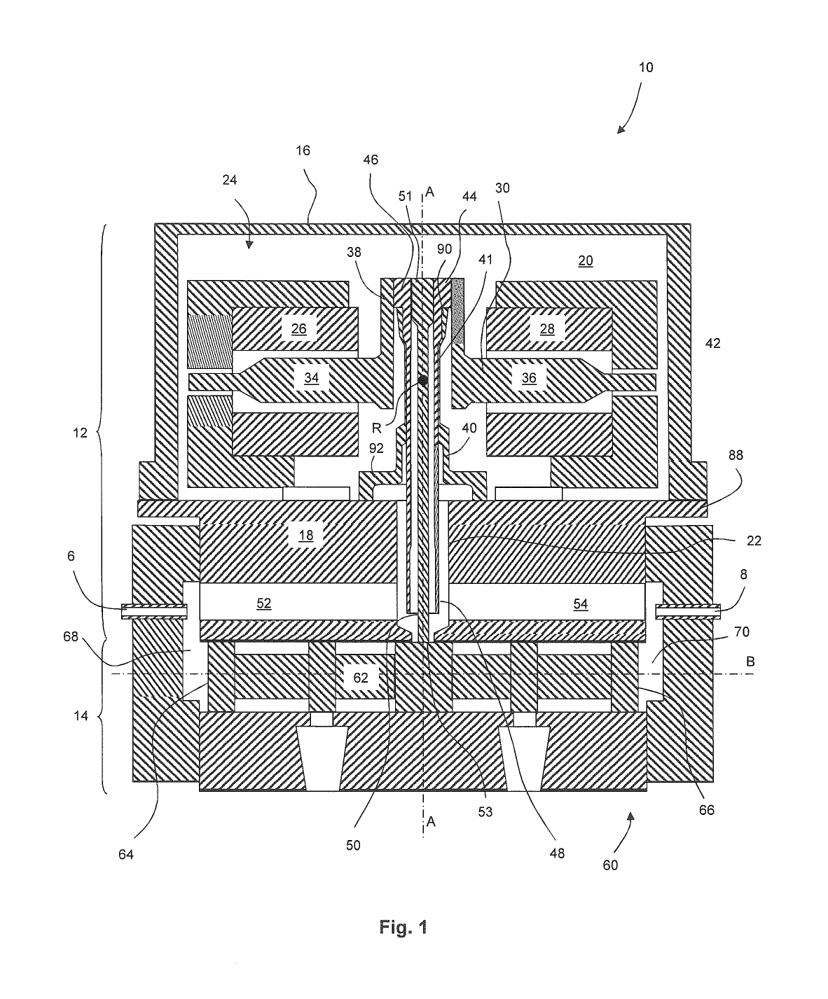

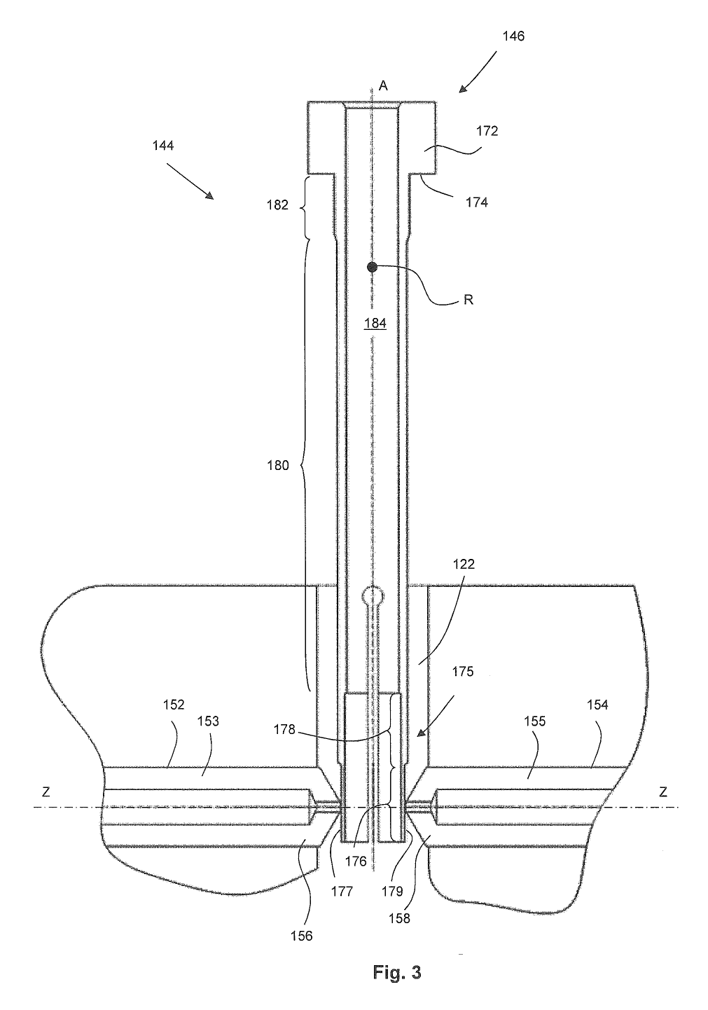

With reference to FIG. 3, the components shown therein are suitable for use in the servovalve of FIG. 1, and as such the description of FIG. 1 is equally applicable the embodiments of the present invention discussed below.

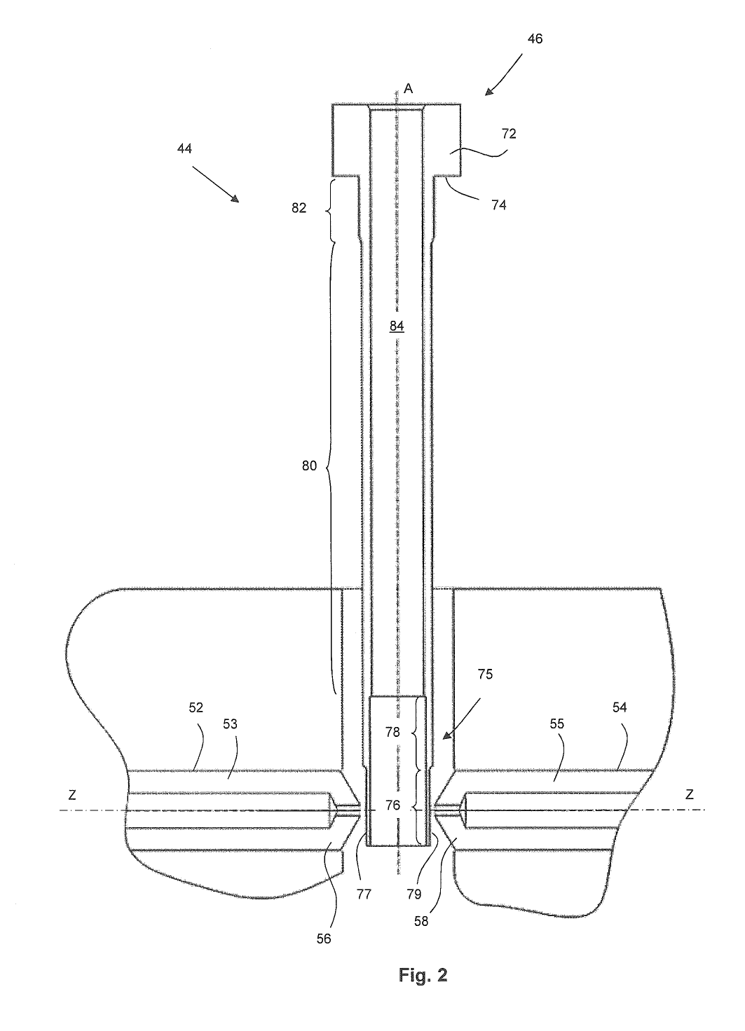

The view shown in FIG. 3 is similar to that of FIG. 2, and an electro-hydraulic servovalve 100 according to the invention as shown therein comprises a flapper 144 which is similar to the flapper 44 as shown in FIG. 2. The flapper 144 is generally tubular and cylindrical in structure. The flapper 144 has a bore 184 concentric therewith. The flapper has a body defining a first region 176, a second region 178, a third region 180 with a higher wall thickness than the first and second regions, and a fourth region 182 which terminates in a shoulder 174. The shoulder 174 defines a collar 172 having a diameter dimensioned for an interference fit with the body 38 of the armature 30 as shown in FIG. 1. As such, the flapper 144 is cantilevered from the armature 30 having a fixed end 146 and a free end 175.

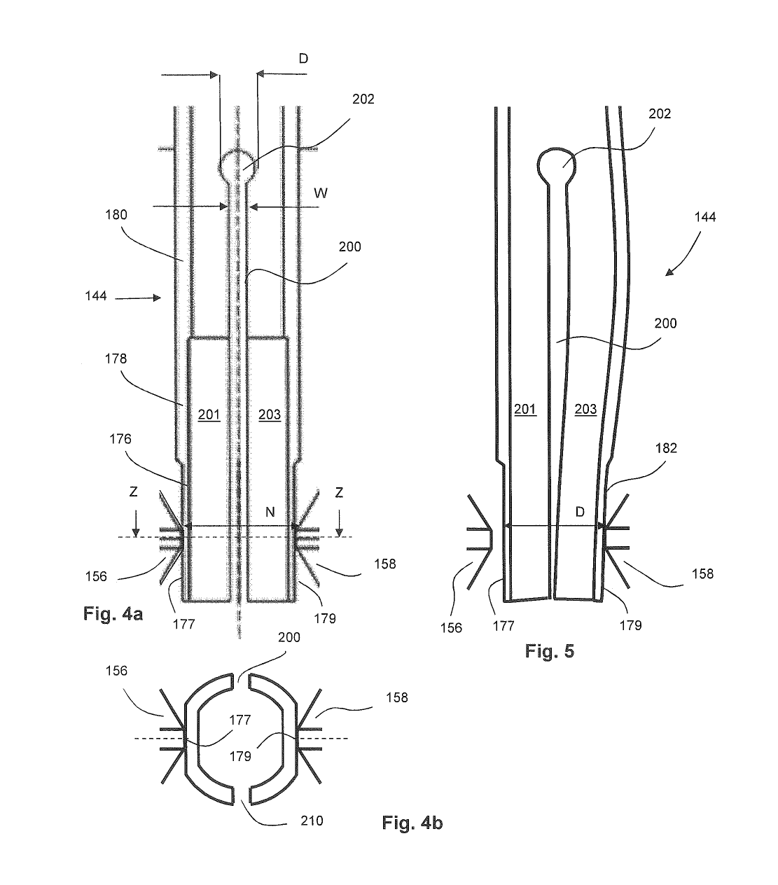

A more detailed view of the flapper 144 can be seen in FIG. 4a. FIG. 4b shows a cross section through the first region 176.

As with the flapper 44, a pair of diametrically opposed flats 177, 179 are provided in the first region 176 (see FIG. 4b). The distance between the flats 177, 179 defines a flapper undeformed width N.

Part of a base 118 is also shown in FIG. 3 comprising a central coaxial bore 122 extending along a main central axis A, and two diametrically opposed bores 152, 154 extending radially from the main central axis A. Each of the bores 152, 154 is in fluid communication with the bore 122. Within each bore 152, 154 there is provided a respective nozzle insert 153, 155 defining a respective fluid nozzle 156, 158. The nozzle inserts 153, 155 are movable along a common nozzle axis Z within the bores 152, 154.

The main difference between the flapper 144 and the flapper 44 is the provision of a pair of identical diametrically opposed slots 200, 210. The slot 200 has width W and extends parallel to the main central axis A from the free end 175 of the flapper 144, through the first region 176, through the second region 178 and into the third region 180, where the slot 200 terminates in a circular region 202 having diameter D. The width of the slot 200 is constant from the free end 148 to the circular region 202 and has a width W less than D. The slots 200, 210 are identical in shape. The slots 200, 210 result in the provision of a first leg 201 and a second leg 203 at the free end 175 of the flapper 144. The first leg 201 comprises the flat 177 and the second leg 203 comprises the flat 179.

As can be seen in FIG. 4a, the nozzles 156, 158 are in direct contact with the flats 177, 179 of the first region 176 of the flapper 144. This can also be seen in FIG. 4b.

In operation, the electro-hydraulic servovalve 100 is operated in much the same way as the valve 10. Taking the same example as described above with respect to the prior art, an anti-clockwise rotation of the armature 30 will result in an anti-clockwise rotation of the flapper 144 about the armature axis R as shown in FIG. 3. Because the flapper 144 is in contact with the nozzles 156, 158, the first region 176 of the flapper 144 cannot move any further to the right in FIG. 5. As such it deforms, compressing the flapper 144 and closing the slot 200. The width of the flapper 144 between the nozzles (and between the flats 177, 179) reduces from the undeformed width N to a deformed width D, where D<N.

The second leg 203 of the flapper 144 deforms by virtue of the reaction between the flat 179 and the nozzle 158. The first leg 201 of the flapper 144 remains straight, but moves away from the nozzle 156 thus opening the gap between the nozzle 156 and the flat 177 and reducing the pressure in the chamber 68 in FIG. 1.

As such, although contact between the nozzle 158 and the flat 179 is maintained (and as such so is the pressure in the chamber 70) the gap opened between the flat 177 and the nozzle 156 lowers the pressure in the chamber 68, and as a consequence, moves the spool to the left.

When returning to the null position, the flapper resiles to its undeformed width N. Deformation of the flapper 144 is kept elastic to avoid permanent deformation.

It will be noted that in the present invention, in the null position there is very little quiescent flow because the flats 177, 179 of the flapper 144 are in contact with the nozzles 156, 158.

In a further embodiment, in order to further reduce the quiescent flow, the flapper 144 may be slightly compressed by contact with the nozzles 156, 158. In other words, a pre-stress may be applied to the flapper compressing the flats to a pre-stress width P, where N>P>D. This provides even better sealing to reduce quiescent flow.

In a still further embodiment, a gap between the nozzles 156, 158 and the flapper 144 may still be present, although made smaller than the prior art. Under these circumstances, the quiescent flow is reduced (although not eliminated). The advantage of this technique is that a pressure rise would be seen in the chamber connected to the nozzle which the flapper moves towards. As such, a higher differential pressure can be applied to the spool.

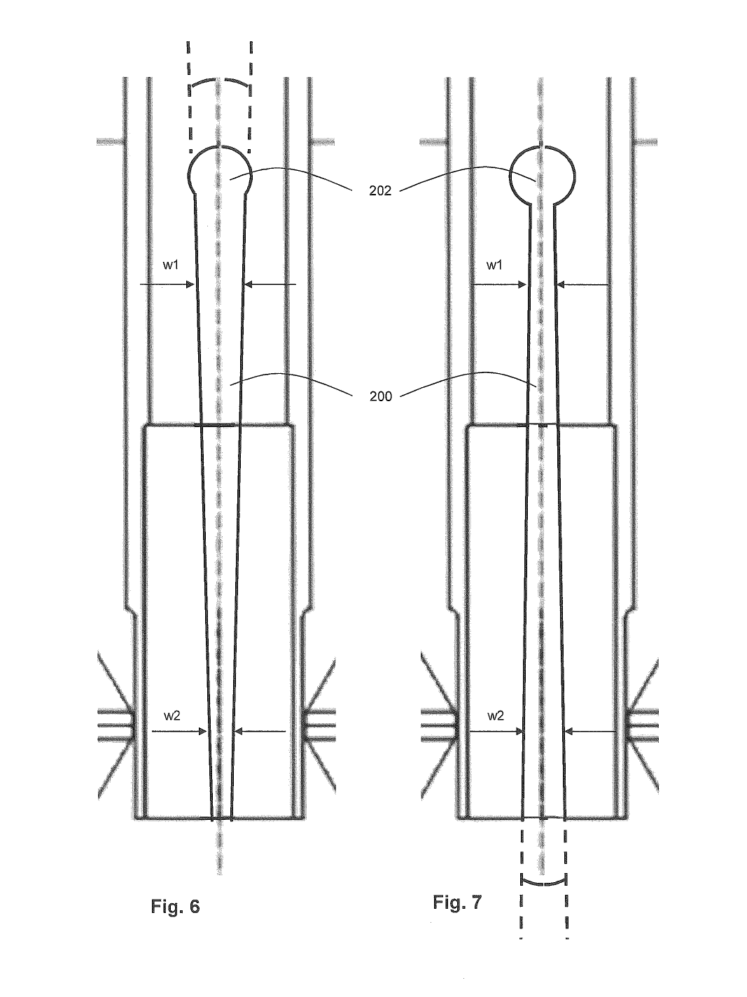

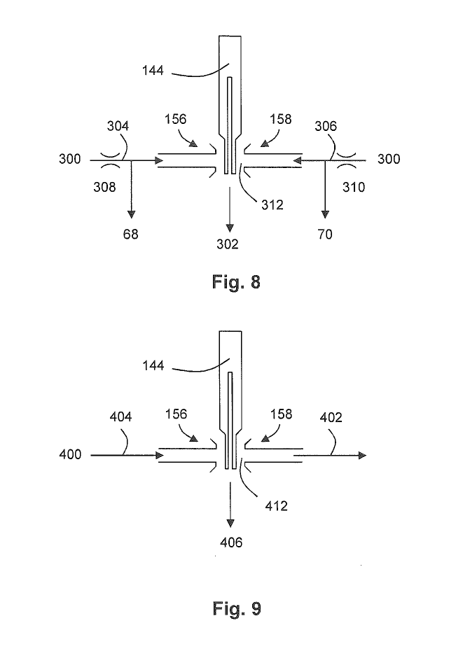

Turning to FIGS. 6 and 7, alternative embodiments are shown in which the slots 200 both converge towards the free end of the flapper such that the slot width narrows from w1 to w2 (FIG. 6), and in which the slots 200 both diverge towards the free end of the flapper such that the slot width broadens from w1 to w2 (FIG. 7). This alters the deformation and spring characteristics of the flapper allowing for its behaviour over the course of it deformation to be tailored to the desired application.

FIG. 8 is a representation of the hydraulic configuration of the present invention, showing the flapper 144 between the nozzles 156, 158. The nozzles 156, 158 and the chambers 68, 70 are fed from a common pressure source 300 via pressure lines 304, 306 passing through restrictors 308, 310 respectively. An inter-nozzle gap 312 feeds to a drain 302. FIG. 8 is a traditional nozzle-flapper configuration with two pressure inlet lines 304, 306.

Turing to FIG. 9, an alternative configuration of a servovalve (a Nozzle/Elzzon configuration) is shown. It is sometimes advantageous to have a hydraulic bridge fed by a single pressure conduit. This is known as “single inlet” the traditional nozzle/flapper bridge described with reference to FIG. 1 is “double inlet” because it has two inlet orifices. A disadvantage with double inlet valves is that in applications where contamination is possible, a piece of fluid borne contamination can block (or partially block) one of the inlet orifices and cause a significant pressure imbalance that can cause the valve to move to one end of its stroke (“hard-over” failure). Such a failure mode does not occur with a single inlet device. If the single inlet starts to block the general performance of the valve will deteriorate (usually the spool will not respond as quickly) but a large offset will not result, leading to more benign failure modes.

Turning to FIG. 9, a single pressure source 400 feeds a pressure line 404 to the nozzle 156 and thence to an inter-nozzle/elzzon gap 412. An “elzzon” 158 (i.e. the opposite to a nozzle—an inlet as opposed to an outlet) opposite the nozzle 156 provides a drain line 402 on the other side of the gap 412. A control outlet 406 is configured to control movement of a spool valve via a control line.

The pressure downstream of the control outlet 406 is determined by the condition of the hydraulic bridge. Therefore the more the flapper 144 moves towards the elzzon 158 the higher the pressure becomes in the outlet 406. Evidently the use of a deformable flapper 144 is advantageous, as the amount of fluid passing from the nozzle 156 to the elzzon 158 can be minimised in the null position. As with the above embodiments, the nozzle 156 and elzzon 158 may be configured to be in contact with the flapper 144.

Unlike the above described embodiments, the embodiment of FIG. 9 has a single control outlet 406. Therefore the spool must be provided with a mechanism for applying an opposite force, such as a spring.

Variations fall within the scope of the present invention.

The servo valve does not need to be an electromagnetic-hydraulic servo valve, and may be actuated by other means, for example a piezoelectric element, a linear force motor or a limited angle torque motor.

Instead of the mechanical feedback wire 50, the main stage may be provided with a movement transducer to provide an electrical feedback signal to a controller which controls the movement of the armature 30 via the provision of power to the windings. As such, electrical feedback is envisaged as a viable alternative to mechanical feedback.

Electrical position feedback may also be added to the pilot element driver, and this can be advantageous in certain applications.

What is claimed is:

1. A servovalve pilot stage assembly comprising:
a first fluid conduit having a first orifice;
a second fluid conduit having a second orifice;
a flapper having a deformable first region disposed between the first orifice and the second orifice;
an actuator arranged to drive the flapper from a first condition in which the first region of the flapper has a first width between the first and second orifice to a second condition in which the first region of the flapper has a second width between the first and second orifice.

2. A servovalve pilot stage assembly according to claim 1, in which the first region of the flapper is locally, structurally weakened to elastically deform.

3. A servovalve pilot stage assembly according to claim 2, in which the flapper defines:
a main longitudinal axis;
a width extending between the orifices; and,
a depth extending normal to the main longitudinal axis and the width;
in which an opening is formed through the depth of the first region of the flapper.

4. A servovalve pilot stage assembly according to claim 3, in which the flapper comprises a free end proximate the first region, and the opening is a blind slot generally extending in direction of the main longitudinal axis from the free end, through the first region to form a first leg and a second leg of the flapper in the first region.

5. A servovalve pilot stage assembly according to claim 1, in which the first region is hollow having a wall and a central cavity.

6. A servovalve pilot stage assembly according to claim 5, in which the flapper defines:
a main longitudinal axis;
a width extending between the orifices; and,
a depth extending normal to the main longitudinal axis and the width;
in which respective openings are formed through opposing sides of the wall of the first region of the flapper.

7. A servovalve pilot stage assembly according to claim 6, in which the flapper comprises a free end proximate the first region, and the openings are blind slots generally extending in direction of the main longitudinal axis from the free end, through the first region to form a first leg and a second leg of the flapper in the first region, in which the blind slots are diametrically opposed.

8. (canceled)

9. A servovalve pilot stage assembly according to claim 4, in which the slot terminates in a curved end region.

10. A servovalve pilot stage assembly according to claim 9, in which the curved end region is partially circular, and in which the circular curved end region has a diameter greater than the width of the slot proximate the circular curved end region.

11. (canceled)

12. (canceled)

13. A servovalve pilot stage assembly according to claim 4 in which the slot tapers outwardly towards the free end of the flapper.

14. A servovalve pilot stage assembly according to claim 4 in which the slot tapers inwardly towards the free end of the flapper.

15. A servovalve pilot stage assembly according to claim 1, in which at least one of the first and second conduits defining the first and second respective orifices are in contact with the first region of the flapper in the first condition.

16. A servovalve pilot stage assembly according to claim 15, in which both the first and second conduits defining the first and second respective orifices are in contact with the first region of the flapper in the first condition.

17. A servovalve pilot stage assembly according to claim 16, in which the first region of the flapper has an undeformed width greater than the distance between the first and second orifices such that in the first condition the first region of the flapper is pre-compressed.

18. A servovalve pilot stage assembly according to claim 1, in which the first region of the flapper defines flats facing the first and second orifices.

19. A servovalve pilot stage assembly according to claim 1, in which the first and second orifices are defined in nozzles directed towards the flapper.

20. A servovalve comprising:
a servovalve pilot stage assembly according to claim 1; and,
a main stage controlled by the pilot stage.

21. A servovalve according to claim 20, comprising a spool valve having a spool defining a first end face in fluid communication with the first conduit, in which the spool defines a second, opposite, end face in fluid communication with the second conduit.

22. (canceled)

23. A servovalve according to claim 20, in which the first conduit is in fluid communication with:
a pressure source such that the first orifice is an outlet; and,
a first part of the main stage,
in which the fluid pressure at the first part of the main stage is controlled by the distance between the flapper and the first orifice, and
in which the second conduit is in fluid communication with:
a pressure source such that the second orifice is an outlet and,
a second part of the main stage,
in which the fluid pressure at the second part of the main stage is controlled by the distance between the flapper and the second orifice.

24. (canceled)

25. (canceled)

26. A servovalve according to claim 20, in which:
the first conduit is in fluid communication with a pressure source such that the first orifice is an outlet;
the second conduit is a connected to a fluid drain such that the second orifice is an outlet;
a third fluid conduit is provided between the first and second fluid orifices in fluid communication with a first part of the main stage;
in which the fluid pressure at the first part of the main stage is controlled by the position of the flapper between the first and second orifices.

27. (canceled)

28. (canceled)
